(19) United States
(12) Patent Application Publication
(10) Pub. No.: US 2025/0265670 A1
(43) Pub. Date: Aug. 21, 2025

(54) DIGITAL PLATFORM FOR SELLING SAFE FOOD

(71) Applicant: Saad Muhammad Ayub, Austin, TX (US)

(72) Inventor: Saad Muhammad Ayub, Irving, TX (US)

(21) Appl. No.: 18/442,477

(22) Filed: Feb. 15, 2024

(51) Int. Cl. G06Q 50/26; G06Q 50/12

(52) U.S. Cl. CPC G06Q 50/265; G06Q 50/12

(57) ABSTRACT

A system and method to sell safe food may include a digital platform. The digital platform system includes a user profile creator, a government-issued document authenticator, a Kitchen Inspection Quiz-administrator, a Kitchen Inspection Quiz-grader, a Kitchen Inspection Quiz-determinator, a Kitchen Inspection Quiz-certificate-generator, certified badge poster, a virtual inspection module, a virtual inspection verificater, a virtual inspection-badge generator, a virtual inspection-badge publisher, and a navigation button, which is configured to be a nexus between and communicates with two or more digital platform components. The method includes a user becoming a seller when the platform authenticates a government-issued safety document/s. A second safety level is obtained by passing a qui, generating, and posting a quiz pass certificate-badge. A third level of food safety is provided by a virtual inspection that resolves food-related quality. A user, seller, may have one, two, three, or any combination of levels of safety levels.

### CROSS-REFERENCE TO RELATED APPLICATIONS

This original Nonprovisional Application does not claim benefit to any prior applications.

### FEDERALLY SPONSORED RESEARCH AND DEVELOPMENT

Not applicable.

The present disclosure relates to an apparatus, method, and system for selling safe food and food products online. The method utilizes a navigation button (covered in detail throughout this application) for online safe food sales.

### BACKGROUND OF THE INVENTION

Prepared and manufactured online food products are a growing industry, including restaurants, cottage industries, and other manufactured products. Restaurants and manufactured food products include local, state-wide, or national chains. However, cottage enterprises are typically small, local, and homemade, often called “cottages.” Generally, the cottage food industry refers to small-scale, home-based businesses that produce and sell food products. Most of these businesses are operated from individuals' homes, often in kitchens that do not meet the same regulatory standards as commercial kitchens.

Each country regulates the restaurant and cottage food industry differently, and each country has its own set of rules and regulations. The food and cottage food industries are regulated differently in each state in the United States, with each state having its own set of rules and regulations. In most cases, these laws provide guidance on the types of food products that may be produced, the food manufacturing and preparation process, the channels through which the products may be sold, and any restrictions that may apply. The small cottage industry regulations generally differ from those required for large-scale commercially manufactured products. This disclosure herein may allow customers to buy any prepared and unprepared food that is safely handled and prepared.

### SUMMARY OF THE INVENTION

This application relates to an apparatus, system, and method for selling safe food and safe food products online. The method utilizes a navigation button for online safe food sales.

The disclosure herein details a platform for selling safe food products, where the sellers may inform the buyers regarding food safety in one or more manners, including food safety preparations, handling, adherence to government regulations, etc.

In some aspects, the techniques described herein relate to the information that may be provided in real-time, near real-time, long-term, or any combination thereof.

In some aspects, the techniques described herein relate to small restaurants, large chain restaurants, cottage industry, manufactured food products, etc., and any combination thereof.

In some aspects, the techniques described herein relate to a method for selling safe food, including a digital platform-controlled creating a user profile, the digital platform-controlled uploading and/or downloading a government-issued safety document, the digital platform-controlled authenticating the government-issued safety document, the digital platform controlled administering a Kitchen Inspection Quiz, the digital platform grading the Kitchen Inspection Quiz, the digital platform determining the Kitchen Inspection Quiz pass/fail, the digital platform generating a platform certified badge upon passing the kitchen inspection quiz, and the digital profile controlled posting of the platform certified badge on the user profile.

In some aspects, the techniques described herein relate to a method, where the user profile/account is for selling food, buying food, or both.

In some aspects, the techniques described herein relate to a method wherein the government-issued document is combined with at least one non-government-issued document for uploading and/or downloading and authenticating.

In some aspects, the techniques described herein relate to a method wherein the digital platform performs authentication using a database matching unit, which matches the uploaded document with a pre-existing database of such documents. If the database matches the uploaded document with another from the database, the authentication test may pass.

In some aspects, the techniques described herein relate to a method wherein a pattern recognition module performs the digital platform authentication.

In some aspects, the techniques described herein relate to a method wherein pattern recognition is combined with a machine learning module.

In some aspects, the techniques described herein relate to a system wherein the digital platform Kitchen Inspection Quiz-administrator includes questions related to food safety, food nutrition, food, and food allergies.

In some aspects, the techniques described herein relate to a method wherein the administration of the Kitchen Inspection Quiz is for food safety.

In some aspects, the techniques described herein relate to a method wherein the administration of the Kitchen Inspection Quiz is for food nutrition.

In some aspects, the techniques described herein relate to a method wherein the Kitchen Inspection Quiz is administered for food allergies.

In some aspects, the techniques described herein relate to a method wherein the platform-certified badge posting is customizable by the user.

In some aspects, the techniques described herein relate to a method wherein further the digital platform controls conducting a virtual inspection using at least one tool, wherein the virtual inspection resolves food-related quality, the digital platform verifies the virtual inspection, and the digital platform controls publishing of a virtual inspection-badge on the user profile.

In some aspects, the techniques described herein relate to a method wherein the digital platform uses tools selected from a group consisting of a video camera, stationary camera, digital thermometers, invoices, vendor documents, or any combination thereof.

In some aspects, the techniques described herein relate to a method wherein the digital platform resolves food quality selected from a group consisting of food freshness, food nutrition, food ingredients, food cleanliness, food cooking tools, food allergens, or any combination thereof.

In some aspects, the techniques described herein relate to a method of becoming a food seller, including steps: the food seller creates a user profile on a digital platform, uploads government issues documents onto the digital platform, the food seller is awaiting the digital platform's approval/denial, and the food seller selling food on the digital platform, wherein the food seller using a navigation button to navigate between two or more steps, wherein the navigation button for each step remaining at the same location on the user profile, and the navigation button dimensions remain unchanged throughout the steps.

In some aspects, the techniques described herein relate to a method wherein the food seller further takes and passes a Kitchen Inspection Quiz, posts a platform-certified badge, and customizes the platform certification badge.

In some aspects, the techniques described herein relate to a method wherein further the food seller conducts a virtual inspection using at least one tool, wherein the virtual inspection resolves food-related quality, awaiting the virtual inspection verification, and customizing the publishing of a virtual inspection badge on the user profile.

In some aspects, the techniques described herein relate to a digital platform system for selling safe food, including a unique user profile creator, a government-issued safety document uploader and/or downloader, a government-issued safety document authenticator, a digital platform Kitchen Inspection Quiz administrator, a digital platform Kitchen Inspection Quiz-grader, a digital platform Kitchen Inspection Quiz-determinator, the digital platform Kitchen Inspection Quiz-certificate-generenator, the digital profile platform certified badge poster, and a navigation button, wherein a navigator button is configured to be a nexus between two or more digital platform components.

In some aspects, the techniques described herein relate to a system wherein the navigation button has the same location and dimensions on the user profile.

In some aspects, the techniques described herein relate to a system wherein the digital platform Kitchen Inspection Quiz-administrator includes questions related to food safety, food nutrition, food, and food allergies.

In some aspects, the techniques described herein relate to a system wherein the digital platform further includes a virtual inspection module, a virtual inspection verification, a virtual inspection-badge generator, and a virtual inspection-badge publisher, and wherein the virtual inspection resolves food-related quality.

In some aspects, the techniques described herein relate to the system, wherein the virtual inspection module further includes at least one tool selected from a group consisting of a video camera, stationary camera, digital thermometers, invoices, vendor documents, or any combination thereof.

### BRIEF DESCRIPTION OF DRAWINGS

FIG. 1. Initial Step of Creating User Profile/Account:

FIG. 2. Initial Authentication Step.

FIG. 3. Authentication Second Step.

FIG. 4. Authentication Complete Step.

FIG. 5. User Sells Food Step.

FIG. 6. Platform Certification Quiz.

FIG. 7. Platform Certification Badge.

FIG. 8. Seller's Profile on the Customer Screen.

FIG. 9. Product Details Screen.

FIG. 10. A method for selling safe food on a digital platform.

FIG. 11. A method of becoming a food seller.

FIG. 12. A digital platform system for selling safe food.

### DETAILED DESCRIPTION OF THE INVENTION

Examples of embodiments are provided so that this disclosure may be thorough and fully convey the scope to those skilled in the art. Numerous specific details are set forth, such as examples of specific components, devices, and methods, to provide a thorough understanding of the embodiments of the present disclosure. It may be apparent to those skilled in the art that specific details need not be employed, that example embodiments may be embodied in many different forms, and that neither should be construed to limit the scope of the disclosure. In some examples, embodiments, aspects, well-known processes, well-known device structures, and well-known technologies are not described in detail; at least one specification heading is required.

The terminology used herein is for the purpose of describing particular example embodiments only and is not intended to be limiting. As used herein, the singular forms “a,” “an,” and “the” may be intended to include the plural forms as well unless the context clearly indicates otherwise. The terms “comprises,” “comprising,” “including,” and “having,” are inclusive and therefore specify the presence of stated features, integers, steps, operations, elements, and/or components but do not preclude the presence or addition of one or more other features, integers, steps, operations, elements, components, and/or groups thereof. The method steps, processes, and operations described herein are not to be construed as necessarily requiring their performance in the particular order discussed or illustrated unless specifically identified as an order of performance. It is also to be understood that additional or alternative steps may be employed.

The preceding summary, as well as the following detailed description of certain embodiments, may be better understood when read in conjunction with the appended figure of experimental data and results. As used herein, an element or step recited in the singular and proceeded with the word “a” or “an” should be understood as not excluding the plural of said elements or steps unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. When a definition is provided herein, it supersedes any other meaning or definition.

The disclosure herein details a platform for selling safe food products, where the sellers may inform the buyers regarding food safety in one or more manners, including food safety preparations, handling, adherence to government regulations, etc.

Food safety is paramount in food sales, including safety during the preparation and manufacturing of food products such as in small restaurants, large chain restaurants, cottage industry, manufactured food products, the cottage food industry (homemade food prepared outside a commercial kitchen and sold to the public), and chefs (sellers) must ensure the food they sell is safe to consume and convey this information to the consumers (buyers). Due to the diversity in each state's strict food handling regulations and certifications, the disclosure herein aims to develop a virtual kitchen and virtual manufacturing facility platform for examination solutions; this food preparation (home or commercial) and manufacturing facilities are referred to herein as kitchens.

The disclosure herein relates to an apparatus, platform, system, and method for selling safe food and food products online. The platform and method utilize a unique navigation button for online safe food sales.

In some aspects, the techniques described herein relate to small restaurants, large chain restaurants, cottage industry, manufactured food products, etc., and any combination thereof.

In some aspects, the techniques described herein relate to a method for selling safe food on a digital platform. The digital platform is configured to both control functions conducted by the user and perform functions itself through various platform components. These functions may be managed by the system, system component/s automatically and/or system, system component manager manually, user/s, or any combination thereof.

In some aspects, the techniques described herein relate to one, two, or more user/s. The user may be one, two, or more food seller/s, food buyers, or both (seller and buyer). One, two, or more users may use the digital platform simultaneously or at different times.

In some aspects, the techniques described herein relate to a digital platform system for selling safe food. The platform has several components namely, a unique user profile creator, a government-issued safety document uploader and/or downloader, a government-issued safety document authenticator, a digital platform quiz-administrator, a digital platform quiz-grader, a digital platform quiz-determinator, the digital platform quiz-certificate-generator, the digital profile certificate poster, and a navigation button, wherein a navigator button is configured to be a nexus between two or more digital platform components.

In some aspects, the techniques described herein relate to a digital platform system for selling safe food, including a unique user profile creator, a government-issued safety document uploader and/or downloader, a government-issued safety document authenticator, a digital platform Kitchen Inspection Quiz-administrator, a digital platform Kitchen Inspection Quiz-grader, a digital platform Kitchen Inspection Quiz-determinator, the digital platform Kitchen Inspection Quiz-certificate-generator, the digital profile platform certified badge poster, and a navigation button, wherein a navigator button is configured to be a nexus between two or more digital platform components.

In some aspects, the techniques described herein relate to a unique user profile creator, which may be used by the user (food seller) to create a profile that may be customizable, with or without using pre-make templates, or both.

In some aspects, the techniques described herein relate to the system and process and involve at least two steps for the first level of food safety information provided to the buyers; in the first step, the sellers may upload one or more state-issued documents. Although the seller guarantees the authenticity of the documents, the disclosure platform may verify the authenticity of the state-issued documents.

In some aspects, the techniques described herein relate to the sellers being able to sell food items on the platform after signing up as a seller. The platform requires all potential sellers to submit at least one document, such as a food handler document (issued by their local government), to sell their food products.

In some aspects, the techniques described herein relate to a government-issued safety document uploader and/or downloader, wherein the user may upload and/or download any government or non-government-issued document/s related to food sold, more specifically related to food safety, nutritious, ingredients, food-allergies, etc., or any combination thereof.

In some aspects, the techniques described herein relate to a government-issued safety document authenticator that may authenticate the documents using one or more manners via at least one or more manners, such as manually, digitally, automatically, another way, etc., or any combination thereof.

In some aspects, the techniques described herein relate to the platform's assessment of the document's authenticity (using an authenticator) as a second step of the first level of food safety, the first step being uploading government or non-government-issued documents. In this second step of the first level of food safety, the platform may approve or deny the request after the certificate is inspected and authenticated via at least one or more manners, such as manually, digitally, automatically, another way, etc., or any combination thereof. After the request is approved, the user may become a platform seller and begin selling food on the platform.

In some aspects, the techniques described herein relate to authenticating the state-issued documents (the second step of the first level) that may be performed manually and/or automatically matching with one or more databases, automatically using an algorithm, automatically using artificial intelligence, another matrix, pattern recognition-related software, etc., or any combination thereof that may identify any irregularities within the documents. The authentication may be done in at least one or more manners.

In some aspects, the techniques described herein relate to the state-issued documents and may be replaced, combined, or both with other local, state, or jurisdiction-issued documents, government or non-government-issued documents.

In some aspects, the techniques described herein relate to the seller's choice of becoming a seller before the authentication of the local, state, or jurisdiction-issued documents, government or non-government-issued documents, etc., or any combination thereof is completed. In this case, a disclaimer may appear on the seller's profile, product details screen, or seller's profile, informing the buyer that the authentication verification is pending.

In some aspects, the techniques described herein relate to the platform's assessment of the document's authenticity as a second step of the first level of food safety, which may lead to a denial due to the inability to authenticate the document/s. In this case of denial, if the seller opts to sell their products still, a disclaimer may be posted on their profile or the product details information screen to inform the buyers of the seller's food safety status.

In some aspects, the techniques described herein relate to additional layers/levels of food safety. This additional food-safety level may require the seller to participate in the digital platform controlled quiz and pass the quiz regarding food-safety protocols the seller implements and the seller's food safety knowledge, etc., or any combination thereof. This quiz is referred to herein as the ‘Kitchen Inspection Quiz.’ These questions may add another layer/level of food safety to the seller's profile, such as one or more platform certifications, which may be badges, icons, images, buttons, text, color, etc., or any combination thereof. Referred to herein as platform certification badge.

In some aspects, the techniques described herein relate to a digital platform. The Kitchen Inspection Quiz administrator may assess the seller's food safety, nutrition, ingredients, food allergies, and other knowledge.

In some aspects, the techniques described herein relate to the questions, which may be related to the seller's food safety, nutrition, ingredients, and other knowledge.

In some aspects, the techniques described herein relate to this Kitchen Inspection Quiz, which aims to assess the seller's qualifications, both food protocols implemented and food knowledge, to run a home/commercial-based food business; this information is provided to the buyer so that the buyers may make an informed decision.

In some aspects, the techniques described herein relate to a digital platform Kitchen Inspection Quiz-grader. The grader may calculate the number of questions the seller answered correctly.

In some aspects, the techniques described herein relate to a digital platform Kitchen Inspection Quiz Determinator that determines the level of seller knowledge and if the seller may qualify for a certificate. If the determinator, the seller, does not qualify for the certificate, it may inform the seller (via email, popup, or another message) that the seller does not qualify and may again take the quiz.

In some aspects, the techniques described herein relate to the digital platform platform-certified badge generator. When the seller is determined to be eligible, this generator may generate a platform-certified badge. This badge may inform the buyer of the seller's knowledge rank.

In some aspects, the techniques described herein relate to the digital profile platform certified badge poster that may finally post the badge on the seller's profile. This may be posted automatically, by the seller, or the platform manager, or any combination thereof.

In some aspects, the techniques described herein relate to a navigation button, which interconnects to two or more digital platform components and may be configured to serve as a nexus, connection, link, communication, etc., or any combination thereof between two or more digital platform components.

In some aspects, the techniques described herein relate to the seller informing the buyers of another second level of safety to become ‘Platform Certified.’ This platform certification badge as a second-level safety badge may be obtained by the seller taking and passing a quiz, which may provide additional benefits to all users (sellers and buyers). If the seller passes the quiz, the seller's credibility may be boosted with the platform certification badge displayed on the seller's profile (when buyers search for a seller) and product details. Buyers may be further informed about the seller's extra safety measures.

In some aspects, the techniques described herein relate to when buyers search for sellers directly through a search tool and/or visit the seller's profile from the product details page or other means. The user (buyer) may see the displayed Platform Certification badge.

In some aspects, the techniques described herein relate to the quiz for the seller's food safety knowledge and use of food safety processes and devices during the food preparation, packaging, etc., or any combination thereof. The quiz may have a mix of 2, 3, 4, 5, 6, 7, 8, 9, 10, 11, 12, 13, 14, 15, 16, 17, 18, 19, 20, or more questions, wherein the questions may be multiple choice, short and/or long answer, matching correct answers from a predetermined list, true/false questions, etc. or any combination thereof.

In some aspects, the techniques described herein relate to the inspection; the seller may be quizzed on ingredients, a combination of ingredients that may be used individually or in any combination.

In some aspects, the techniques described herein relate to the part of the inspection; the seller may be asked about kitchen cleanliness and safety protocols such as time for cooked or uncooked food ingredients at room temperature, refrigerated, or freezer; not microwaving stainless steel or aluminum items, etc., or any combination thereof.

In some aspects, the techniques described herein relate to maintaining the platform certification badge. The seller must take and pass a quiz periodically, such as every week, monthly, quarterly, semi-annually, annually, etc., or any combination thereof. Questions may be randomly picked from an extensive question/s database/s to minimize the chances of repeating the same questions for the same or different buyers.

In some aspects, the techniques described herein quiz may be related to non-safety food questions such as nutritional information of the prepared sold food, ingredients used, allergenic foods, etc., or any combination thereof.

In some aspects, the techniques described herein relate to a sub-category of second-level quizzes referred to herein as the ‘Kitchen-Inspection-Quiz-Sub-Category.’ For example, the seller might want to take and pass a quiz regarding food-borne allergens; in this case, the seller may take and pass Kitchen Inspection-Quiz-Allergy. In another example, the quiz might pertain to food nutrition or using organic ingredients and take and pass Kitchen Inspection-Quiz-Nutrition or Kitchen Inspection-Quiz-Organic. Several such quizzes may be possible, such as Kitchen Inspection-Quiz-Food Safety, Kitchen Inspection-Quiz-Vegetarian, Kitchen Inspection-Quiz-Vegan, Kitchen Inspection-Quiz-Halal, Kitchen Inspection-Quiz-Dairy Free, Kitchen Inspection-Quiz-Kosher, Kitchen Inspection-Quiz-Glutin Free, Kitchen Inspection-Quiz-Nut Free, Kitchen Inspection-Quiz Peanut Free, Kitchen Inspection-Quiz-Keto, Kitchen Inspection-Quiz-Carnivore, Kitchen Inspection-Quiz-Fat Free, Kitchen Inspection-Quiz Low Carbohydrate, Kitchen Inspection-Quiz No Carbohydrate, etc., or any combination thereof.

In some aspects, the techniques described herein relate to a sub-category of level two (second level) certification. For example, the seller might take and pass a quiz regarding food-borne allergens; in this case, the seller may obtain a Platform Certification-Allergy. In another example, the quiz might pertain to food nutrition or using organic ingredients and get a Platform Certification-Nutrition or Platform Certification-Organic. Several such certificates may be possible, such as Platform Certification-Food Safety, Platform Certification-Vegetarian, Platform Certification-vegan, Platform Certification-Halal, Platform Certification-Dairy Free, Platform Certification-Kosher, Platform Certification-Gutin Free, Platform Certification-Nut Free, Platform Certification-Peanut Free, Platform Certification-Keto, Platform Certification-Carnivore, Platform Certification-Fat Free, Platform Certification-Low Carbonydrate, Platform Certification-No Carbohydrate, etc., or any combination thereof.

In some aspects, the techniques described herein relate to these forms of authentication (submitting the government or non-government, non-platform issued authenticatable document/certificate and taking one or more quizzes to obtain one or more Platform Certification issued), which may provide additional confidence and knowledge to buyers/customers. These may assist buyers to choose from two or sellers with the same or similar products.

In some aspects, the techniques described herein relate to an optional third level of food safety that may be utilized. At this level, a virtual inspection may be performed, which may be a thorough examination or scrutiny that includes tools such as but is not limited to kitchens, cooking equipment, food quality, packing material, etc. The inspections may include photographs, video, digital thermometers, digital cameras, audio equipment, and invoices/vendor documents to determine ingredients' freshness, quality, safety, nutrition, etc., or any combination thereof. These tools may assist in thoroughly examining food handling, safety measures through scrutiny, allergens, and nutritious and food-safety thoughtfulness in preparing food items and goods.

In some aspects, the techniques described herein relate to a system wherein the digital platform further includes a virtual inspection module, a virtual inspection verification sub-module, a virtual inspection-badge generator, and a virtual inspection-badge publisher, and wherein the virtual inspection resolves food-related quality.

In some aspects, the techniques described herein relate to resolving food-related quality, wherein the food-related quality is food information such as nutritional information of the prepared sold food, ingredients used, food freshness, ingredients quality (organic, non-organic, etc.), cleanliness of food ingredients, tools, packaging materials, allergenic foods, etc., or any combination thereof.

In some aspects, the techniques described herein relate to the system, wherein the virtual inspection module includes at least one tool selected from a group consisting of a video camera, stationary camera, digital thermometers, invoices, vendor documents, or any combination thereof.

In some aspects, the techniques described herein relate to the system, wherein the virtual inspection module further includes at least one tool selected from a group consisting of a video camera, stationary camera, digital thermometers, invoices, vendor documents, or any combination thereof.

In some aspects, the techniques described herein relate instead of having a third party individual visit a seller's (home chefs, restaurant-chefs, manufacturing facility) preparation and manufacturing facilities at their home or business, the platform may opt to streamline the process of kitchen safety by introducing a multi-layered approach that may boost a seller's (chef's, etc.) privileges on the platform based on the assessments they provide to the platform and other checks they may pass.

In some aspects, the techniques described herein relate to the information that may be provided in real-time, near real-time, long-term, or any combination thereof.

In some aspects, the techniques described herein relate to the information regarding food safety, food safety methodology, food safety certification, preparation premises, food safety ingredients, nutrition, food ingredients used, etc., or any combination thereof.

In some aspects, the techniques described herein relate to a third-level sub-category of food safety that may be utilized. These sub-categories may relate to food safety and/or non-safety food information such as nutritional information of the prepared sold food, ingredients used, food freshness, ingredients quality (organic, non-organic, etc.), cleanliness of food ingredients, tools, packaging materials, allergenic foods, etc., or any combination thereof.

Another aspect of the disclosure is using a navigation button with two or more (multiple) functionality and user experience. A significant feature of the navigation button is that it remains in the same location (unchanged location) and has the same dimensions at every step of each user's screen usage. Therefore, the user experience is convenient and easy. However, the navigation button may have a different look, text, image, logo, color, etc., or any combination thereof on different user screens and different user steps. This navigation button may be considered to be the same navigation button due to the unchanged location and dimensions on each screen or step.

In some aspects, the techniques described herein relate to a system wherein the navigation button has the same location and dimensions on the user profile.

Herein is described as a navigation button method for food sales of this disclosure that may enhance food sales and provide information to online buyers regarding food safety and/or non-safety food information such as nutritional information of the prepared sold food, ingredients used, allergenic foods, ingredients used, food freshness, ingredients quality (organic, non-organic, etc.), cleanliness of food ingredients, tools, packaging materials, allergenic foods, etc., or any combination thereof.

Depending on the screen and step, the navigation button may present multiple User Interface/User Experience (UI/UX) experiences to the buyer and seller. As a result of the disclosure, buyers, and sellers may be provided with a platform for interacting with each other to sell and buy food based on information provided on the platform.

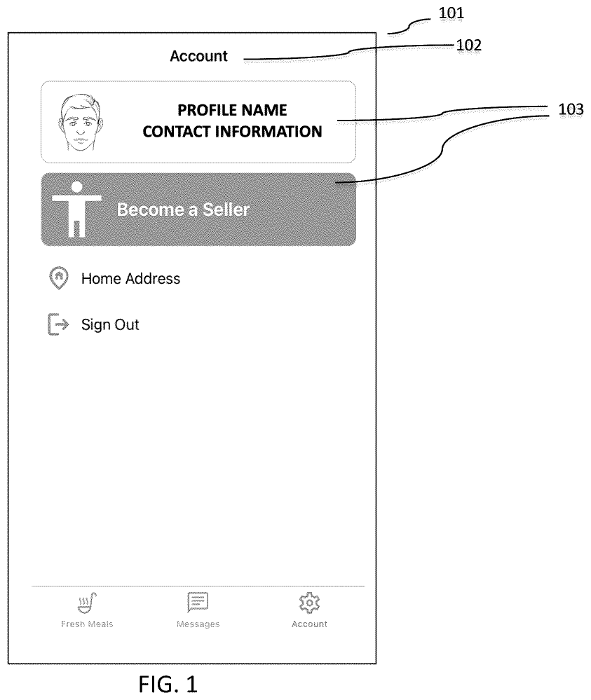

In some aspects, the techniques described herein relate to the levels/layers of the chef (seller) authentication process and may be handled using a navigation button. Regular chefs can become sellers by submitting their food-safety government and/or non-government-issued certificates. The same navigation button may allow them to take and pass one or more quizzes to provide further information regarding themselves and earn further badge/s, thus enhancing and boosting their sales after they become sellers. A banner may be displayed on their account page once they pass the quiz, and they may customize the banner's appearance (after passing the quiz). In addition, the button may have different colors, icons, and text at different stages, as seen in the screenshots (FIG. 1-7).

In some aspects, the techniques described herein relate to a method for selling safe food, including a digital platform controlled creating a user profile, the digital platform controlled uploading and/or downloading a government-issued safety document, the digital platform controlled authenticating the government-issued safety document, the digital platform controlled administering a Kitchen Inspection Quiz, the digital platform grading the Kitchen Inspection Quiz, the digital platform determining the Kitchen Inspection Quiz pass/fail, the digital platform generating a platform certified badge upon passing the kitchen inspection quiz, and the digital profile controlled posting of the platform certified badge on the user profile.

In some aspects, the techniques described herein relate to a system wherein the digital platform Kitchen Inspection Quiz administrator includes questions related to food safety, food nutrition, food, food allergies, etc., or any combination thereof.

In some aspects, the techniques described herein relate to a method where the user profile/account is for selling food, selling food, buying food, etc. or any combination thereof.

In some aspects, the techniques described herein relate to a method wherein the government-issued document is combined with at least one non-government-issued document for uploading and/or downloading and authenticating.

In some aspects, the techniques described herein relate to a method wherein the digital platform authentication is performed by a database matching unit. The unit may have one or more databases, and the uploaded document may be matched with this database. In the event a match is found, the platform and authenticator may authenticate the uploaded document.

In some aspects, the techniques described herein relate to a method wherein a pattern recognition module performs the digital platform authentication. The module may further have artificial intelligence-based algorithms, etc., or any combination thereof.

In some aspects, the techniques described herein relate to a method wherein pattern recognition is combined with machine learning or training modules.

In some aspects, the techniques described herein relate to a method wherein the administration of the Kitchen Inspection Quiz is for food safety.

In some aspects, the techniques described herein relate to a method wherein the administration of the Kitchen Inspection Quiz is for food nutrition.

In some aspects, the techniques described herein relate to a method wherein the administration of the Kitchen Inspection Quiz is for food allergy.

In some aspects, the techniques described herein relate to a method wherein the platform certification badge posting is customizable by the user. For example, the customization may be in the badge color, text, seller logo, picture, title, video, etc., or any combination thereof.

In some aspects, the techniques described herein relate to a method wherein the digital platform further controls conducting a virtual inspection using at least one tool. The virtual inspection may be managed and/or controlled by the digital platform but conducted by the seller/user of the digital platform. The virtual inspection resolves/determines food-related quality, the digital platform verifies the virtual inspection, and the digital platform controls the publishing of a virtual inspection badge on the user profile/account. The user may customize the badge.

In some aspects, the techniques described herein relate to a method wherein the digital platform uses tools selected from a group consisting of a video camera, stationary camera, digital thermometers, invoices, vendor documents, or any combination thereof.

In some aspects, the techniques described herein relate to a method wherein the digital platform resolves food quality selected from a group consisting of food freshness, food nutrition, food ingredients, food cleanliness, food cooking tools, food allergens, or any combination thereof. For example, photos/videos may assist the platform in determining food freshness; videos, cooking tools, and audio may determine food cleanliness; invoices and other vendor documents may determine food ingredients, allergies, nutrients, etc., or any combination thereof.

In some aspects, the techniques described herein relate to a method of becoming a food seller, including steps: the food seller creates a user profile/account on a digital platform, the food seller uploads government-issued documents onto the digital platform, the food seller may awaiting the digital platform's approval/denial, and the food seller selling food on the digital platform, wherein the food seller using a navigation button to navigate between two or more steps, wherein the navigation button for each step remaining at the same location on the user profile/screen, and the navigation button dimensions remain unchanged throughout the steps on the user profile/screen.

In some aspects, the techniques described herein relate to a method wherein the food seller further takes and passes a Kitchen Inspection Quiz, posts a platform certification badge, and customizes the platform certification badge.

In some aspects, the techniques described herein relate to a method wherein further the food seller conducts a virtual inspection using at least one tool, wherein the virtual inspection resolves food-related quality, awaiting the virtual inspection verification, and customizing the publishing of a virtual inspection badge on the user profile

In some aspects, the techniques described herein relate to a method of resolving food-related quality, wherein the food-related quality is food information such as nutritional information of the prepared sold food, ingredients used, food freshness, ingredients quality (organic, non-organic, etc.), cleanliness of food ingredients, tools, packaging materials, allergenic foods, etc., or any combination thereof.

The disclosure herein details a method for a button for cottage food (or other commercial food sales, such as restaurants, small restaurants, restaurant chains, etc., or any combination thereof) sales that may enhance food sales and provide information regarding food safety. Nutrition, allergies, etc., to online buyers. The button may present multiple User Interface/User Experience (UI/UX) experiences for the seller and buyer and may change (concerning the background color, title/subtitle, and icon) with each screen and step. The disclosure provides a platform for buyers and sellers to interact to sell and buy food goods.

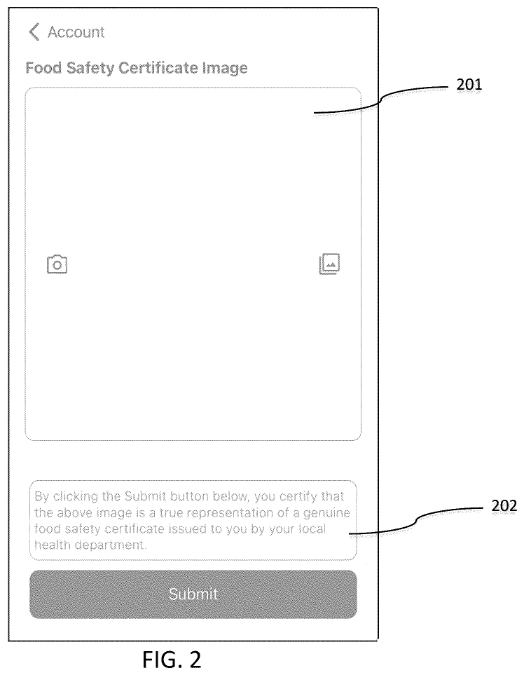

Example: A user (someone already signed up on the platform as a user) may want to become a food seller on the platform and may first need to go through the necessary steps via mobile, Web, or a similar application. During this process, the user may submit a request via the app's Account section using the button (FIG. 1). The user may then be presented with a new screen (FIG. 2) that allows the user to submit a food handler/safety government or non-government certificate, or any other food-safety-related documents that the local health department may have issued to the user. This screen allows the user to take a picture of their food handler certificate/other certification document (camera button) or select an existing picture from the photo gallery (gallery button).

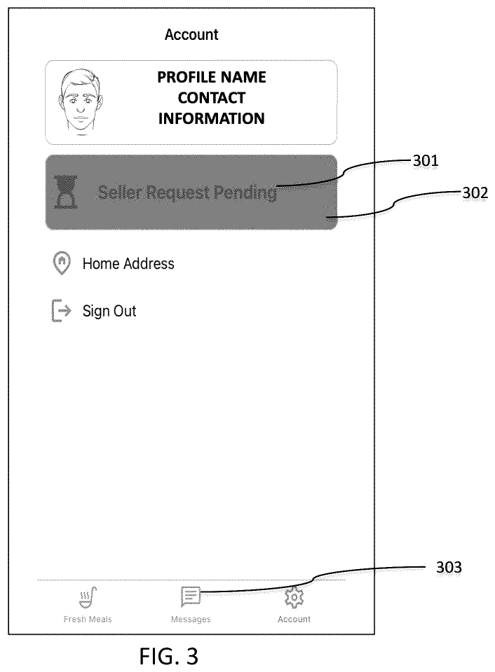

The user who has submitted a request to become a seller may be able to see a ‘Seller Request Pending’ (or similar) text on the same navigation button (FIG. 3). Although the color, title, icon, etc. of the button may change from when the user initially clicked on the button to become a seller, the button remains the same (same location and dimensions). Furthermore, the button may be disabled until the user's request to become a seller may be approved or declined from the back end. Moreover, all the provided UI/UX may likely change without altering the main flow managed by the button. If a seller request has been submitted, the user may see the text on the same navigation button (FIG. 3): ‘Seller Request Pending’ or another similar text. The color of the button and the images or the icon displayed may differ from when the user initially clicked on the button to become a seller. In addition, the button may be disabled at this stage until the user has been authenticated (the request to become a seller may be approved, declined, or pending) from the backend. Moreover, the look and feel of all the UI/UX may likely change without affecting the main flow navigated by the button.

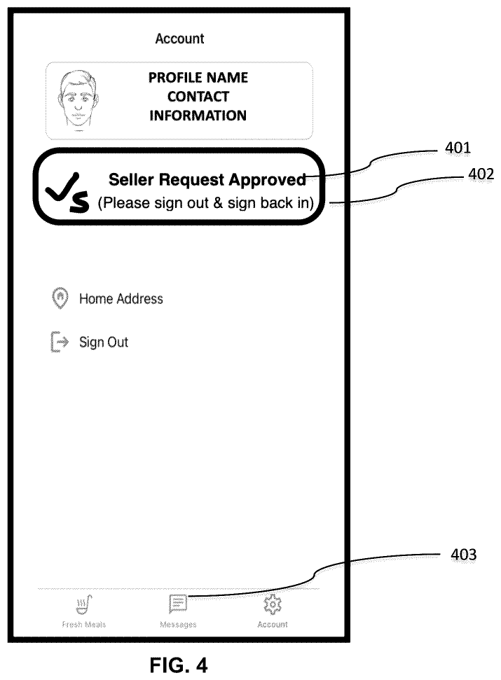

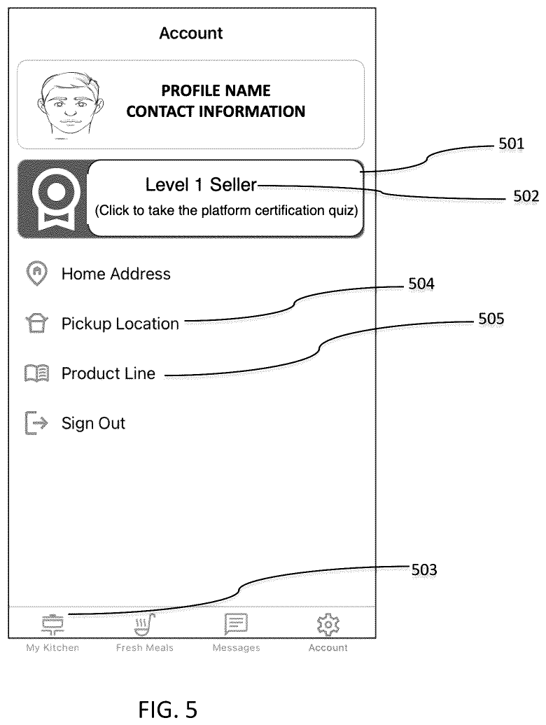

The user's request may be approved. The platform's backend (any digital platform system components including local or iCloud storage) may store the user's new status and may send an email or instant message (within the app) asking the user to sign out and sign back in to experience the seller/chef specific UI elements. Furthermore, at this stage, the navigation button in the Account section may also inform the user of the approval of the seller request and instruct the user to sign out and sign back in (FIG. 4). Because the app communicates with the backend (any digital platform system components including local or iCloud storage) regarding the status of the user when the user signs back in after the approval, it displays the appropriate UI/UX elements, including the additional ‘My Kitchen’ bottom tab (FIG. 5). Additionally, there are two more seller-specific options in the Account/Profile section ('Pickup Location' and ‘Product Line’ on FIG. 5). The color, text, image, and/or icon on the navigation button may also be updated. The user may now start selling food products on the platform using the app and, as the navigation button label suggests (FIG. 5), may also optionally become further ‘Platform Certified’ by taking multiple-choice, true/false, short answer, or any combination thereof questions (this may be 1, 2, 3, 4, 5, 6, 7, 8, 9, 10, or more multiple choice questions followed by 1, 2, 3, 4, 5, 6, 7, 8, 9, 10, or more true/false questions, or a similar variation with any combination of questions just mentioned). Please note that a seller may also buy food items from other sellers, just like a regular user of the app platform. In addition, it is important to note that the UI/UX of all the provided screens may change without affecting the flow managed by the navigation button.

The platform may provide food sellers (chefs) with a quick authentication and verification process, the legitimacy of their skills, which may enhance and boost their profile in the platform's search algorithm, and no third-party visits, nor does the platform require waiting periods for passes or failures. Quizzes may also have different questions every time.

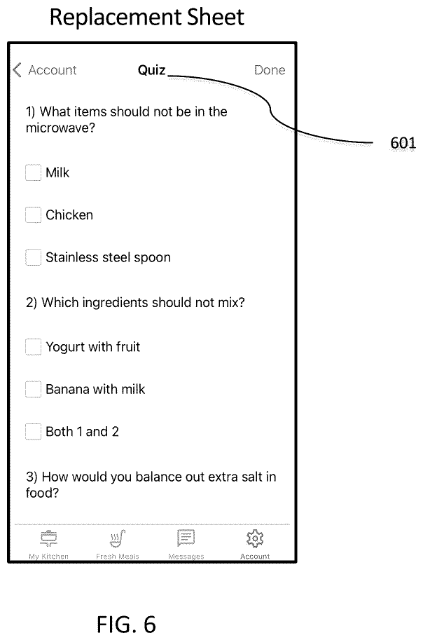

A screen similar to (FIG. 6) may appear if the user clicks the button on the previous screen (FIG. 5) to become platform-certified. The questions may be randomly selected from a large pool of questions stored in the platform's database on the backend side. To make the quiz more efficient, the main pool of questions may constantly change.

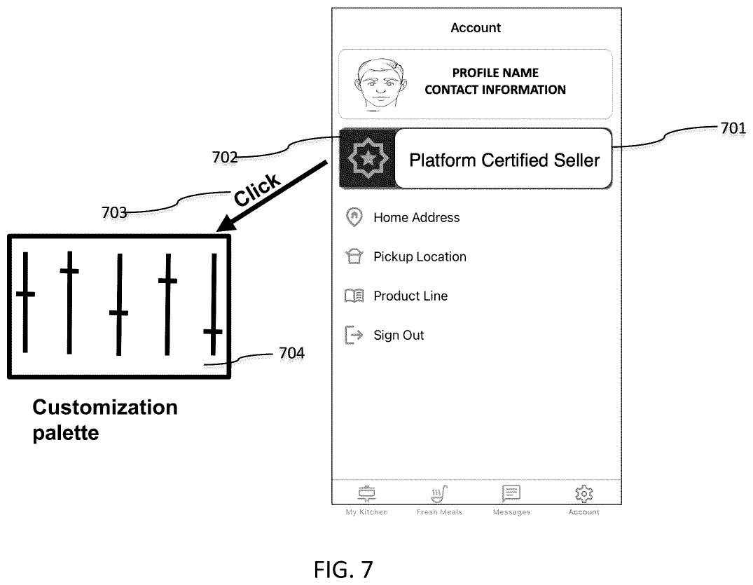

The user correctly answers at least 80% (this may change in other examples, such as 95%, 90%, 85%, 80%, 75%, 70%, 65%, 60%, etc., or any combination thereof) of the questions to become ‘Platform Certified’. In the event that the user fails the quiz, he or she may still be able to sell food products because he or she holds a food handler's certificate issued by the local health government department/another regulatory authority. The user may also take the quiz as often as necessary (pressing the navigation button as FIG. 1) until a passing grade may be achieved. After passing the quiz, the app may send the data back to the backend for storage (any digital platform system components including local or iCloud storage) and display a confirmation message (either via popup or another method). At this stage, the user may be presented with the screen shown in FIG. 7.

After passing the ‘Platform Certification’ quiz, the navigation button may act as a banner with a badge to give the seller a sense of accomplishment and give buyers more confidence in the seller's food safety, as shown in the screenshot (FIG. 7). It may be that the button's color gradient begins with one color, for example, yellow, and transitions to another color, for example, deep orange. The user may customize the navigation button's (in this case, a banner) look and feel and, by clicking it again, may be presented with a customization palette wherein background images, logos, icons, patterns, color gradients, etc., or any combination thereof can be added or customized on the navigation button. The backend (any digital platform system components including local or iCloud storage) may store all of the banner's look and feel details regardless of whether the user customizes it or leaves it as is.

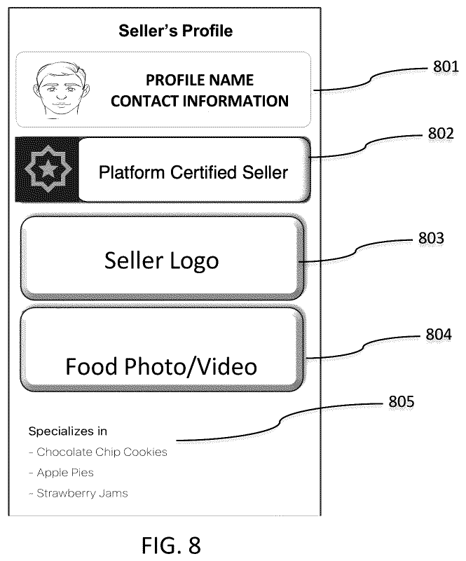

The same banner that a seller sees on his/her Account/Profile section may also appear when a buyer looks up the seller's profile on the platform (FIG. 8). If the seller customizes the banner through the color palette, the same customized banner may also appear on the seller's profile on the customer's side. This may be accomplished by pulling the saved banner information from the application's backend (any digital platform system components, including local or iCloud storage). The banner may not appear on the seller's profile page if they did not take and pass the ‘Platform Certification’ quiz.

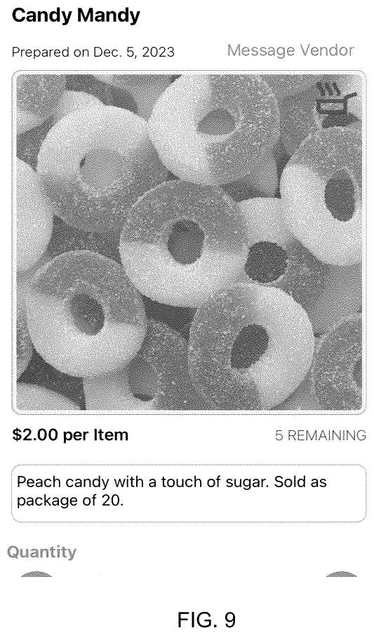

The platform allows sellers to post new listings (a new food product for customers to purchase) by filling out a simple form with product details such as title, image, description, unit price, quantity, etc., and any combination thereof. A picture of the food product may be taken directly with the camera (camera button) or selected from the gallery (gallery button). Upon viewing the product details page before purchasing a product, if the seller is ‘Platform Certified’ and a camera and/or microphone took an image, video, and/or audio, the image, video, or audio may appear with a badge at the top right corner (FIG. 9). It is important to specify to the buyer/customer that this information may be actual information in real or near real-time of the food product, not an outdated photo or doctored information from a gallery. As a result of this method of marketing food items, the seller may be further incentivized to become platform-certified and pay attention to details when preparing food items. The badge on the product details page may not appear on the screen if the user is not platform-certified or if the image was loaded from a gallery. As previously mentioned, the UI/UX of this screen and all the other screens in this document may change, but the flow managed by the navigation button may always remain unchanged.

An artificial intelligence (AI) module with or without a pattern recognition unit may be used to analyze photos, videos, audio, etc., of freshly prepared items and may provide a verification badge based on color, hue, and overall imagery (this applies to photos just captured and not images that the chef/seller uploads from their photo gallery or copies from the internet).

Analyze and collect large amounts of data using artificial intelligence. Analyzing regional and location-based information, which may show buyers/customer preferences for types of food and information on regional diseases (i.e., obesity and malnutrition), may be used to fight obesity, malnutrition, food-related diseases, for example, diabetes, infections, etc. For instance, the highest prevalence of diabetes may be found in the following states: Mississippi, West Virginia, Louisiana, Texas, South Carolina, Alabama, and Georgia; therefore, AI-based analyses may promote sugar-free food options in these areas. AI for the use of reducing poverty and hunger. By identifying where children and populations may be hungry and offering them wholesome and nutritious cottage food alternatives. All cottage food items may include a list of ingredients and a brief description of how they were prepared. AI can also inspire chefs to cook items based on weather conditions and various holiday items.

The user in addition to the submit button, there may be a disclaimer on this screen (FIG. 2). If the user selects a certificate image (either through the camera or gallery) and submits the request, the certificate image and the user's identifiable information, such as their email address and full name, may be sent to the platform's backend (hosted either by a third party cloud hosting platform such as Amazon Web Services or by digital platform's data center) and stored. Upon sending the request, the user may receive a confirmation message (either a screen pop-up or other means).

### DETAILED DESCRIPTION OF THE FIGURES

FIG. 1. Initial Step of Creating User Profile/Account: This is the screen that any user (buyer and/or seller) may see on the digital platform [101]. A regular user (someone who signed up on the platform) who is not a seller is considered a buyer on the platform. The platform user can become a food seller from the ‘Account/Profile’ page shown in this figure [102]. The user can customize their profile or use a pre-set template. The customization may be regarding the text color, text font, text size, picture/photo size and or size, logos, etc., and any combination thereof. This step and process may be controlled by the digital platform and conducted or semi-conducted by the user.

As soon as the user selects to become a seller, the image in FIG. 2 may appear, which requires the user to upload/submit a food safety certificate, which may or may not be issued by the government relevant to the seller's craft. Upon uploading the certificate, the platform may perform authentication. Authentication may be done in several different ways-manually, using a database, automatically, AI, algorithm, or any combination thereof. In the meantime, while the authentication may be pending, the potential seller may see a screen like FIG. 3. After the approval is done, the seller may see a screen like FIG. 4 in the Profile/Account section asking her/him to sign out and sign back in. Once the user signs back in, she/he may see the seller-specific UI elements (FIG. 5) and may begin selling food items.

By taking a quiz (FIG. 6), they can also become ‘Platform Certified.’ If they become certified and pass the quiz, they may receive a badge (visible on the customer's side when the customer searches for the seller on the platform or visits the seller's profile through a link) to boost their profile. The badge may also appear on the seller's Account/Profile screen.

FIG. 2. Initial Authentication Step. After the potential seller clicks the navigation button the first time, it will allow the user to upload/submit a food handler/safety certificate/document issued by the seller's local government department of health or equivalent [201]. The user may have two options: taking a picture of their food handler safety certificate through the camera button or uploading an already saved picture from the photo gallery through the gallery button (not shown). After selecting the certificate image (via camera or gallery) and submitting the request, the certificate/document image and the user's identifiable information, such as but not limited to the user's email and full name, will be sent to the digital platform's backend server (which may or may not be hosted either by a third parties cloud hosting platform such as Amazon Web Services or the platform's own data center, iCloud, etc.) and be stored. A confirmation message will also appear (either via a screen popup, email, or some other method), notifying the user that the request has been sent. On submitting the request, the user may be asked to certify that the uploaded certificate/document is authentic and accurate [202]. The user may also have the option of loading more than two documents that government and/or non-government entities may issue.

FIG. 3. Authentication Second Step. This figure shows the step when the food seller awaits the digital platform's approval/denial [301]. As soon as the request to become a seller has been submitted, the user will see a ‘Seller Request Pending’ text on the navigation button [301]. As a result of clicking on the navigation button to become a seller, the color of the button, the icon, and the text may change and may differ from those displayed when the user initially clicks the navigation button for authentification to become a seller. Furthermore, the navigation button may be disabled until the seller's request has been approved [302]. If declined, the navigation button may return to the original step/screen (FIG. 1), and the reason may be communicated for the denial via a popup screen, email, or another way; the user may rectify the problem by communicating directly or indirectly with a digital platform manager [303].

FIG. 4. Authentication Complete Step. The navigation button may inform the user that the seller request has been approved and ask her/him to sign out and sign back in to access the seller-specific UI elements [401]. Also, the navigation button's background color, text, and icon may change without affecting the flow, this change may or may not be customizable [402]. The digital platform may communicate with the user via a popup screen, email, or another way [403].

FIG. 5. User Sells Food Step. After authentication is completed and the user has signed out and signed back in, the navigation button may have a different color, image/s, text, and/or icon [501]. In this case, the title of the navigation button may let the user know that she/he is a seller [502]. The UI/UX elements specific to sellers are also displayed (including the additional “My Kitchen” tab at the bottom as the screen communicates with the backend server of the digital platform regarding the status of the user when the user signs in again after the verification approval [503]. The account/profile section may include two or additional seller-specific options, for example, ‘Pickup Location’ and ‘Product Line’ [504, 505].

In addition to selling food products on the platform, users may optionally become ‘Platform Certified’ by answering questions, as shown in FIG. 6. The UI/UX of all the user screens may change without affecting the flow managed by the navigation button. In this instant, the navigation button has a subtitle notifying the seller that she/he may now become ‘Platform Certified’ by taking the quiz [502].

FIG. 6. Platform Certification Quiz. If the user clicks on the navigation button in FIG. 5, she/he may see the quiz screen [601]. The digital platform Kitchen Inspection Quiz Administrator may use questions randomly selected from a large database of questions stored on the backend server of the digital platform. To make the quiz more efficient and relevant, the main pool of questions may constantly change and update. In this example, the quiz is made of 5 multiple-choice questions (the screen can be scrolled). To pass the quiz, the user may need to get an 80% score (4 out of 5 correct) correct answers in this example, but any other correct percentage of questions may be used. A digital platform Kitchen Inspection Quiz-Grader may grade the quiz, and a digital platform Kitchen Inspection Quiz-Determinator may determine if the user obtained a passing grade. When the digital platform Kitchen Inspection Quiz is passed, a Kitchen Inspection Quiz-Certificate-generator may generate a Platform Certified Badge.

If the user fails the quiz, the local health department's food government or non-government-issued document may still allow the user to sell food products, but the seller may remain on level 1. However, it is also possible for the user to take the quiz as many times as necessary (by clicking the navigation button) until a passing grade has been achieved. As soon as the quiz is successfully completed, the platform may send the data to the backend for storage and display a confirmation message (either via email, popup, or in some other manner).

FIG. 7. Platform Certification Badge. After the seller has passed the quiz, the second-level Platform Certified Badge may appear on the navigation button in the Account/Profile section of the seller's screen [701]. The badge may be seen as a colorful banner (with one or more stars or another symbol) [702] and may also appear on the seller's profile when seen from the buyer's or customer's side. This banner gives the seller a sense of accomplishment and promotes the user's brand. On clicking the banner (still the button) [703], the seller may also customize the banner's look and feel (including background color, text color, gradient, logo, and/or any combination thereof) from a color/customization palette [704]. Whether the seller customizes the banner or leaves it at the default settings, the banner details will be stored on the backend server side. The colors, icons, element placements, and/or other details within the screens mentioned above may change. There may, however, be no change in the flow of actions.

FIG. 8. Seller's Profile on the Customer Screen. This is the view that the buyer or customer sees when opening the Seller's Profile. When a customer looks up a seller's profile through a search or other means within the platform, she/he may see the exact same badge from the seller's Account/Profile section as mentioned before. This may be done by retrieving the stored banner data from the digital platform's server side.

FIG. 9. Product Details Screen. This is the view that the customer sees when the Product Details screen is open. This screen may display information such as the product title, preparation date, product image, unit price, quantity remaining, product description, and/or any other additional details that may be of value to the customer. Please note that if the seller is ‘Platform Certified’ and took the picture of the food item through the camera when creating the listing (items currently for sale), a badge (similar to the one shown towards the top right of the product image on FIG. 9) may be shown on the Product details screen.

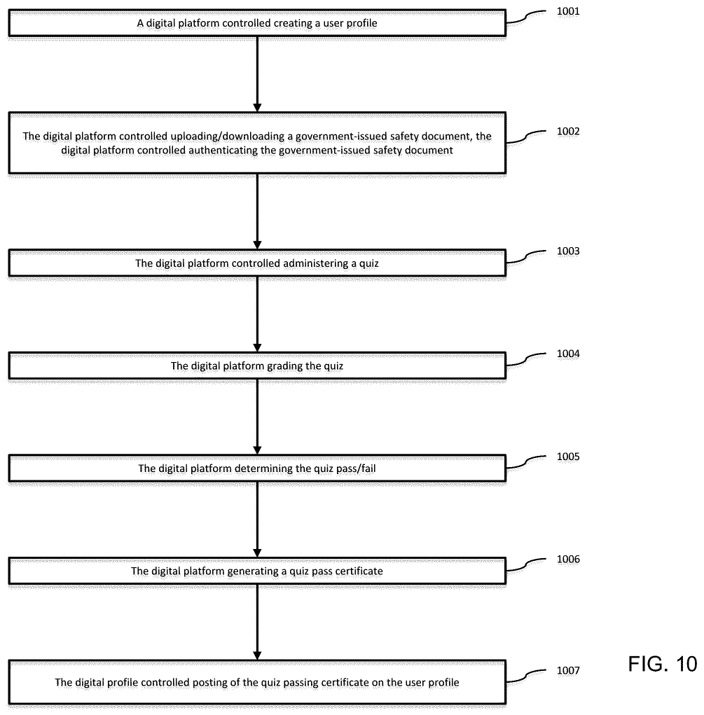

FIG. 10A method for selling safe food on a digital platform. The steps for selling food on a digital platform are described herein. A user creates an account or profile on the digital platform; the platform may or may not control part or complete profile or action creation. [1001]. The user then uploads and/or downloads one or more government and/or non-government-issued documents regarding food safety [1002]. The digital platform may fully or partially control the uploading and/or downloading of the issued document. The digital platform may authenticate the government and/or non-government-issued safety document/s [1002]. The authentication may be via one or more manners, such as but not limited to pattern recognition, manual or automatic matching with database/s containing the issued documents, etc., or any combination thereof. The pattern recognition module and/or the automatic matching unit may further use one or more components of artificial intelligence, learning or training modules, algorithms, profiling modules, memory enables, planning modules, action modules, dataset alignment, Handcrafting, language-generating modules, memory module, memory structures, etc., or any combination thereof. The user may take and pass a quiz that the digital platform may control and administer via an administrator [1003]; a digital platform grader may grade the quiz, and the pass/fail may be determined by a detrminator [1004, 1005]. The quiz may be referred to as a kitchen inspection quiz and may have sub-categories. Upon passing the quiz, the user may get a Platform Certified Badge that may be created by a generator and posted on the user profile by a poster [1007].

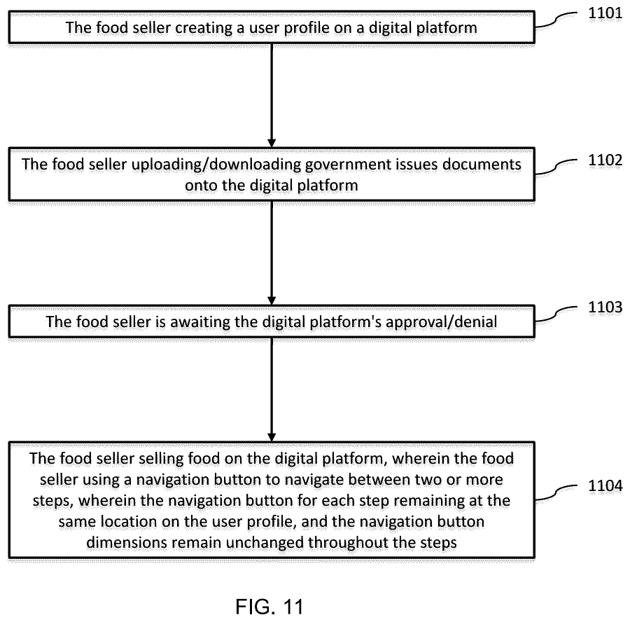

FIG. 11. A method of becoming a food seller. The digital platform user may become a food seller on the platform. As an initial step, the food seller creates a profile on a digital platform [1101], and then the user uploads government and/or non-government-issued documents onto the digital platform [1102]; the food seller may await the digital platform's approval/denial [1103], and the food seller selling food on the digital platform. The food seller uses a navigation button to navigate between two or more steps [1104]; the navigation button for each step remains at the same location on the user profile, and the navigation button dimensions remain unchanged throughout the steps [1104].

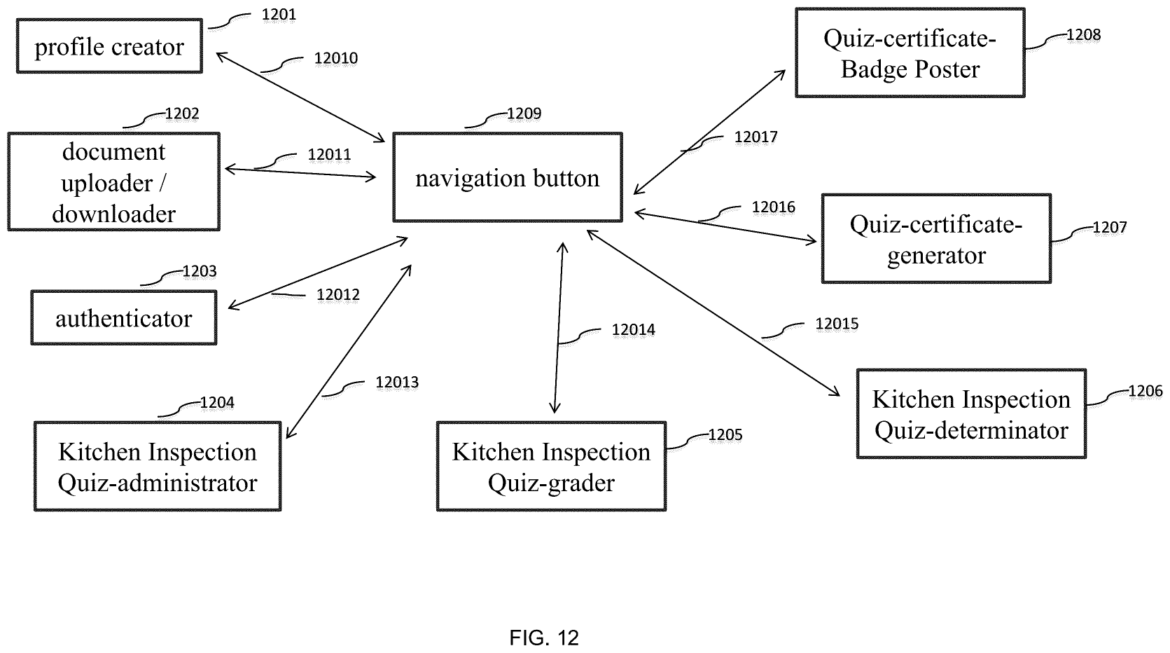

FIG. 12. A digital platform system for selling safe food. The system may include a

unique user profile creator [1201], which may also create an account for a user. The user may be a food seller, a food buyer, or both. One, two, or more users may use the system at the same or different times. The system also includes a document uploader and/or downloader that may be used to upload or download a non-government and/or government-issued safety document [1202]. The document may be authenticated by an authenticator [1203]. The system may include a Kitchen Inspection Quiz-administrator [1204], a digital platform Kitchen Inspection Quiz grader [1205], a digital platform Kitchen Inspection Quiz determinator [1206], the digital platform Kitchen Inspection Quiz-certificate-generator [1207] to generate a platform certified badge, the digital profile platform certified badge poster [1208], and a navigation button [1209]. The navigation may be configured to be a nexus between two or more digital platform components, and the button may communicate with one or more of the system components detailed herein [1210]-[1217]. The nexus and communication may be uni and/or bi-directional. One or more system components may directly or indirectly communicate with and/or be connected to one or more other components (not shown). The system may also include other commuter components such as but not limited to a processor, a motherboard, RAM, GPU, hard drive, solid state drive, software, audio/visual cards, graphic cards, optical drive, a local or iCloud storage, servers, power supply, cooling system, connectivity units, etc., or any combination thereof.

It is to be understood that the above description is intended to be illustrative and not restrictive. For example, the above-described embodiments (and/or aspects thereof) may be used in combination with each other. In addition, many modifications may be made to adapt a particular situation, method, system device, or material to the teachings of the various embodiments of the invention without departing from their scope. While the particulars and details described herein are intended to define the parameters of the various embodiments of the invention, the embodiments are by no means limiting and are exemplary embodiments. Many other embodiments may be apparent to those of skill in the art upon reviewing the above description. The scope of the various embodiments of the invention should, therefore, be determined with reference to the appended claims, along with the full scope of equivalents to which such claims are entitled.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements or steps that do not differ from the literal language of the claims, or if the examples include equivalent structural elements or steps with insubstantial differences from the literal language of the claim.

We claim:

1. A method for selling safe food on a comprising:
a digital platform controlled creating a user profile,
the digital platform controlled uploading of a government-issued safety document, the digital platform controlled authenticating the government-issued safety document,
the digital platform controlled administering a kitchen inspection quiz,
the digital platform grading the kitchen inspection quiz,
the digital platform determining the kitchen inspection quiz pass/fail,
the digital platform generating a platform certified badge upon passing the kitchen inspection quiz, and
the digital profile controlled posting of the platform certified badge on the user profile.

2. The method of claim 1, where the user profile is for selling food.

3. The method of claim 1, wherein combining the government-issued document with at least one non-government-issued document for uploading and authenticating.

4. The method of claim 1, wherein the digital platform authenticating is performed by a database matching unit.

5. The method of claim 1, wherein the digital platform authenticating is performed by a pattern recognition module.

6. The method of claim 5, wherein the pattern recognition is combined with a machine learning module.

7. The method of claim 1, wherein the administering of the kitchen inspection quiz is for food safety.

8. The method of claim 1, wherein the administering of the kitchen inspection quiz is for food nutrition.

9. The method of claim 1, wherein the administering of the kitchen inspection quiz is for food allergy.

10. The method of claim 1, wherein the platform certified badge posting is customizable by the user.

11. The method of claim 1, wherein further the digital platform controlled conducting a virtual inspection using at least one tool, wherein the virtual inspection resolving food-related quality,
the digital platform verifying the virtual inspection, and
the digital platform controlled publishing a virtual inspection badge on the user profile.

12. The method of claim 11, wherein the digital platform using tools selected from a group consisting of a video camera, stationary camera, digital thermometers, invoices, vendor documents, or any combination thereof.

13. The method of claim 11, wherein the digital platform resolving food quality selected from a group consisting of food-freshness, food-nutrition, food ingredients, food cleanliness, food cooking tools, food allergens, or any combination thereof.

14. A method of becoming a food seller on a digital platform comprising steps:
the food seller creating a user profile on the digital platform,
the food seller uploading government issues documents onto the digital platform,
the food seller is awaiting the digital platform's approval/denial, and
the food seller selling food on the digital platform,
wherein the food seller using a navigation button to navigate between two or more steps,
wherein the navigation button for each step remaining at the same location on the user profile screen, and the navigation button dimensions remain unchanged throughout the steps on the user profile screen.

15. The method of claim 14, wherein the food seller further taking and passing a kitchen inspection quiz,
posting a platform certified badge, and
customizing the platform certification badge.

16. The method of claim 14, wherein further the food seller conducting a virtual inspection using at least one tool, wherein the virtual inspection resolving food-related quality,
awaiting the virtual inspection verification, and
customizing the publishing of a virtual inspection badge on the user profile.

17. A digital platform system for selling safe food comprising: a user profile creator, a government issued safety document uploader, a government issued safety document authenticator, a digital platform kitchen inspection quiz-administrator, a digital platform kitchen inspection quiz-grader, a digital platform kitchen inspection quiz-determinator, the digital platform kitchen inspection quiz-certificate-generator, the digital profile platform certified badge poster, and a navigation button, wherein a navigator button is configured to be a nexus between two or more digital platform components.

18. The system of claim 17, wherein the navigation button has a same location and dimensions on the user profile screen.

19. The system of claim 17, wherein the digital platform kitchen inspection quiz-administrator comprises of questions related to food safety, food nutrition, food, and food allergies.

20. The system of claim 17, wherein the digital platform further comprising: a virtual inspection module, a virtual inspection verificater, a virtual inspection badge generator, and a virtual inspection badge publisher, and wherein the virtual inspection resolves food-related quality.

21. The system claim of 20, wherein the virtual inspection module further comprises at least one tool selected from a group consisting of a video camera, stationary camera, digital thermometers, invoices, vendor documents, or any combination thereof.

22.
